(19) United States
(12) Patent Application Publication
(10) Pub. No.: US 2020/0042951 A1
(43) Pub. Date: Feb. 6, 2020

(54) CALCULATION SYSTEM, CALCULATION METHOD, AND RECORDING MEDIUM ON WHICH CALCULATION PROGRAM IS RECORDED

(71) Applicant: NEC CORPORATION, Tokyo (JP)

(72) Inventor: Hironobu MORI, Tokyo (JP)

(73) Assignee: NEC CORPORATION, Tokyo (JP)

(21) Appl. No.: 16/498,506

(22) PCT Filed: Mar. 20, 2018
(86) PCT No.: PCT/JP2018/010937

§ 371 Date: Sep. 27, 2019

(30) Foreign Application Priority Data
Mar. 31, 2017 (JP) 2017-069456

(51) Int. Cl. G06Q 10/10

(52) U.S. Cl. CPC G06Q 10/1097

(57) ABSTRACT

Even when the number of elements increases in an allocation problem, a calculation system can acquire an appropriate combination, and when a plurality of tasks whose start time and end time can each be shifted within a period between a predetermined start time and a predetermined end time are executed as many as possible without overlapping in time, the calculation system includes a scheduling unit converting task data that indicate distribution of a plurality of the tasks, into a directed graph that includes a start and a goal, and detecting the longest path from the start to the goal, and a solution output unit outputting the detected longest path.

### TECHNICAL FIELD

The present invention relates to a calculation system, and particularly relates to a calculation system that solves an allocation problem.

### BACKGROUND ART

The allocation problem is a problem of determining which element among elements (b1, b2, b3 . . . ) of a set B is allocated to an element (a1, a2, a3 . . . ) of a set A (FIG. 1). Generally, in the allocation problem, as the number of elements increases, the number of combinations increases in an order of factorial. When attempting to search an enormous number of the combinations for the optimum combination, it takes an enormous processing time. For this reason, generally, in the allocation problem, as the number of elements increases, it becomes more difficult to acquire the optimum combination (a combination explosion).

For example, in a case where it is decided to assign, to a worker C and a worker D, in unoccupied time sections, work that can be done only by either one of the workers, a question concerning, in order to maximize a total of working time, who is suitable to be asked to do the work at which time section is considered. The unoccupied time sections of the workers C and D in one day are assumed as illustrated in FIG. 2. In other words, this is a problem of allocating elements of a set of unoccupied time sections of the workers C and D in one day, to elements of a set of working time sections.

It is assumed that, in order to solve the problem, the following conditions are satisfied. (1) There is only one piece of equipment for performing the work, and a plurality of persons cannot do the work simultaneously. (2) The work is always performed from a start to an end of the unoccupied time section, and the work is not started from a middle of the unoccupied time section or finished in a middle of the unoccupied time section. Under the conditions, a total of working time is maximized.

As a result, in a case of a lower part of FIG. 2, the work can be done for the maximum of “13 hours”.

### CITATION LIST

### Patent Literature

[PTL 1] Japanese Unexamined Patent Application Publication No. 2008-064081

[PTL 2] Japanese Unexamined Patent Application Publication (Translation of PCT Application) No. 2012-504800

[PTL 3] Japanese Unexamined Patent Application Publication No. 2013-254368

[PTL 4] Japanese Unexamined Patent Application Publication No. 2003-29988

### SUMMARY OF INVENTION

### Technical Problem

In the above-described example, the number of elements to be considered is set to be small, and for this reason, the optimum combination can be acquired by repeating minor trial and error. However, when the number of workers is increased, the number of pieces of equipment for performing work is increased, and a worker is allowed to be replaced in a middle of an unoccupied time section, the number of elements to be considered increases, and then it becomes difficult to acquire the optimum combination. An object of the present invention is to solve the above-described problem.

### Solution to Problem

A calculation system according to the present invention includes: when a plurality of tasks whose start time and end time can each be shifted within a period between a predetermined start time and a predetermined end time are executed as many as possible without overlapping in time, a scheduling unit converting task data that indicate distribution of the plurality of tasks into a directed graph that includes a start and a goal, and detecting a longest path from the start to the goal; and a solution output unit outputting the longest path being detected.

A calculation method according to the present invention includes: when a plurality of tasks whose start time and end time can each be shifted within a period between a predetermined start time and a predetermined end time are executed as many as possible without overlapping in time, converting task data that indicate distribution of the plurality of tasks into a directed graph that includes a start and a goal; detecting a longest path from the start to the goal; and outputting the longest path being detected.

A calculation program according to the present invention causes a computer to execute: when a plurality of tasks whose start time and end time can each be shifted within a period between a predetermined start time and a predetermined end time are executed as many as possible without overlapping in time, processing of converting task data that indicate distribution of the plurality of tasks into a directed graph that includes a start and a goal; processing of detecting a longest path from the start to the goal; and processing of outputting the longest path being detected.

Note that the object of the present invention may be achieved by a recording medium on which the above-described calculation program is recorded.

### Advantageous Effects of Invention

According to the present invention, in the allocation problem, the optimum combination is able be efficiently acquired.

### BRIEF DESCRIPTION OF DRAWINGS

FIG. 1 is a concept diagram of an allocation problem.

FIG. 2 is an illustration of an example of the allocation problem.

FIG. 3 is an illustration of a generalized allocation problem according to an example embodiment of the present invention.

FIG. 4 is a diagram illustrating a data structure of task data according to the example embodiment of the present invention.

FIG. 5 is a block diagram illustrating a configuration of a calculation system according to the example embodiment of the present invention.

FIG. 6 is a flowchart illustrating an entire operation of the calculation system according to the example embodiment of the present invention.

FIG. 7 is a flowchart illustrating processing of initialization of the calculation system, according to the example embodiment of the present invention.

FIG. 8 is a diagram illustrating data structures of (a) a from-candidate list, (b) an event queue, and (c) deployment task information, according to the example embodiment of the present invention.

FIG. 9 is a flowchart illustrating processing of scheduling of the calculation system, according to the example embodiment of the present invention.

FIG. 10 is a flowchart illustrating processing of deploying a task and setting the task in the event queue, according to the example embodiment of the present invention.

FIG. 11 is a flowchart illustrating processing of setting a relation between tasks, according to the example embodiment of the present invention.

FIG. 12 is a flowchart illustrating processing of updating the from-candidate list, according to the example embodiment of the present invention.

FIG. 13 is a flowchart illustrating processing of outputting a solution, according to the example embodiment of the present invention.

FIG. 14 is a block diagram illustrating one example of a hardware configuration of a computer device according to the example embodiment of the present invention.

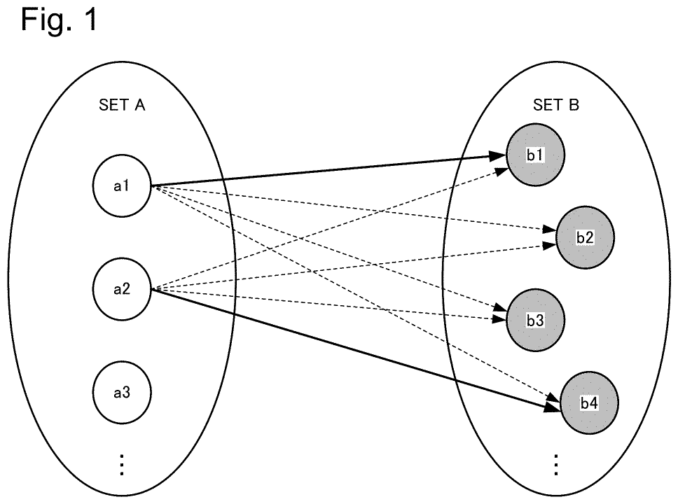

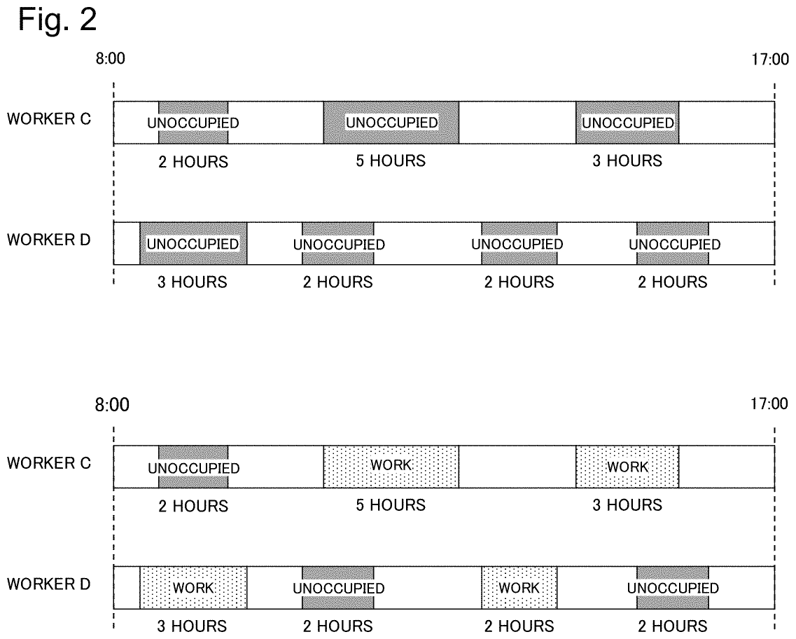

### EXAMPLE EMBODIMENT

Hereinafter, an example embodiment of the present invention is described in detail with reference to the drawings. Note that in the following description, the same reference symbols are attached to elements having the same functions, and description thereof is omitted in some cases.

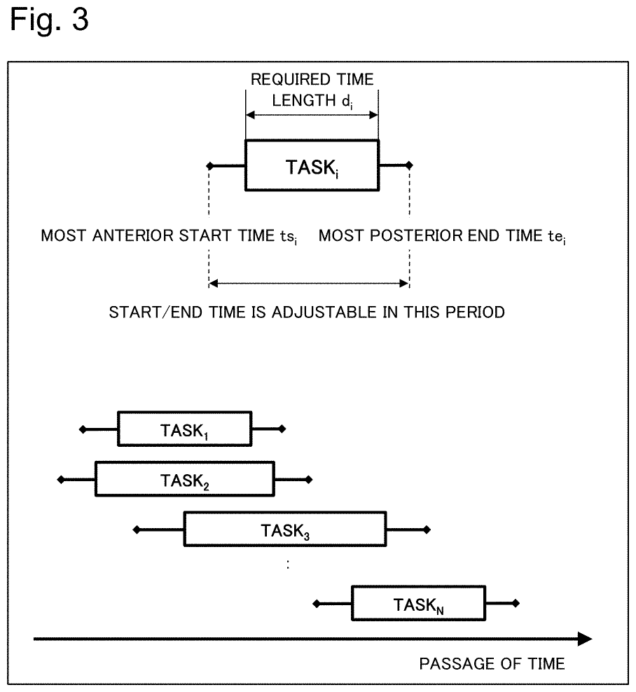

FIG. 3 is an illustration of a generalized allocation problem according to the example embodiment of the present invention. In the example embodiment of the present invention, the allocation problem generalized as follows is solved. Specifically, the allocation problem that a plurality of tasks are allocated as many as possible without overlapping in time from start time Ts to end time Te is solved. The task is work. In a pre-definition, the task is work that is executed continuously for a required time length d in a period from a most anterior start time ts to a most posterior end time te, and a start time and an end time can be shifted. A plurality of the defined tasks are collectively referred to as task data.

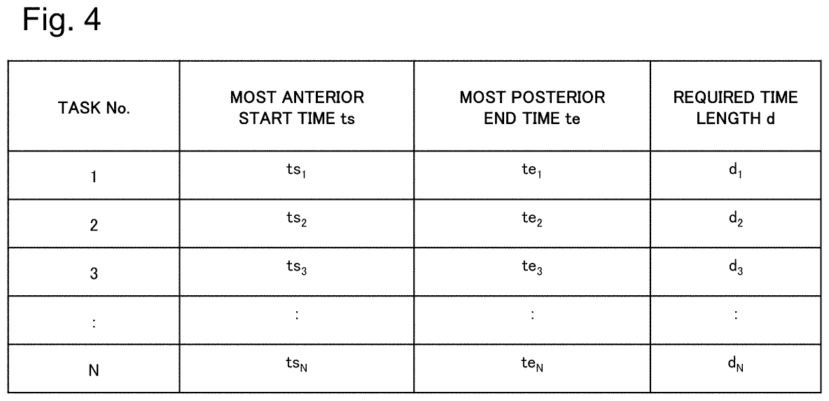

FIG. 4 is a diagram illustrating a data structure of the task data according to the example embodiment of the present invention. The task data are data including items of task No., most anterior start time ts, most posterior end time te, and required time length d.

### (Configuration)

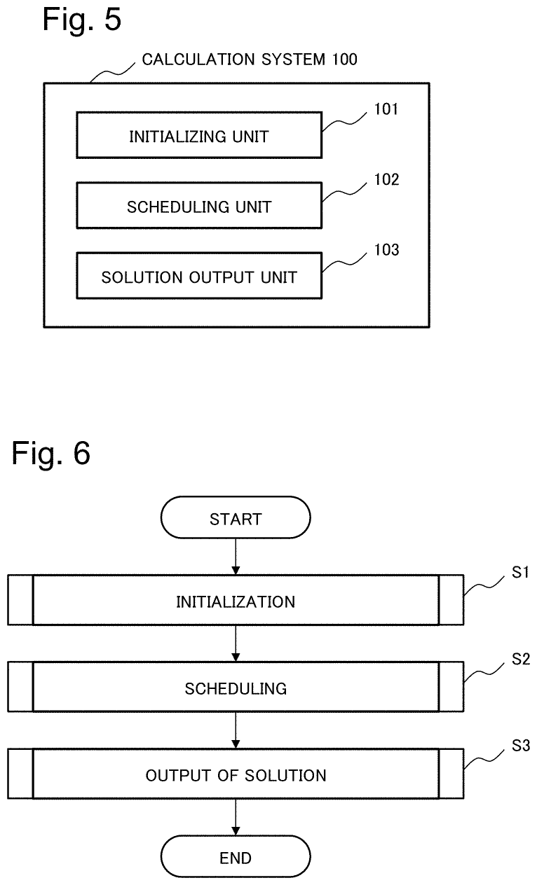

FIG. 5 is a block diagram illustrating a configuration of a calculation system according to the example embodiment of the present invention. The calculation system 100 according to the example embodiment of the present invention includes an initializing unit 101, a scheduling unit 102, and a solution output unit 103.

### (Operation)

FIG. 6 is a flowchart illustrating an entire operation of the calculation system according to the example embodiment of the present invention. The entire operation is roughly divided into three pieces of processing of initialization S1, scheduling S2, and solution output S3. Hereinafter, details of the respective pieces of processing are described.

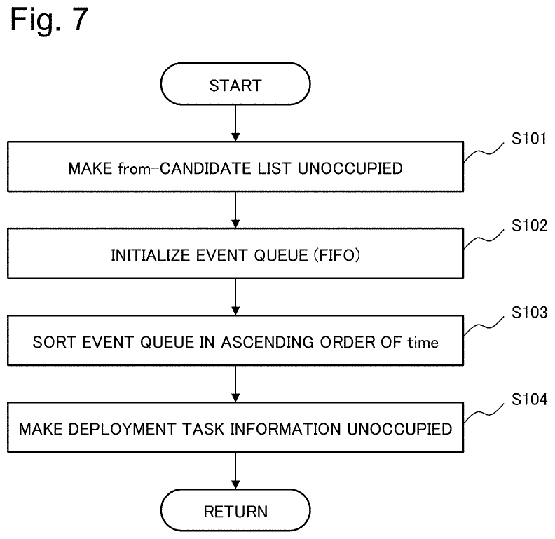

FIG. 7 is a flowchart illustrating the processing of initializing the calculation system according to the example embodiment of the present invention. The following describes the processing of the initialization S1.

The initializing unit 101 substitutes “unoccupied” for all elements in a column of “task No.” in a from-candidate list, and substitutes “unoccupied” for all elements in a column of “deployment No.” in the from-candidate list (step S101).

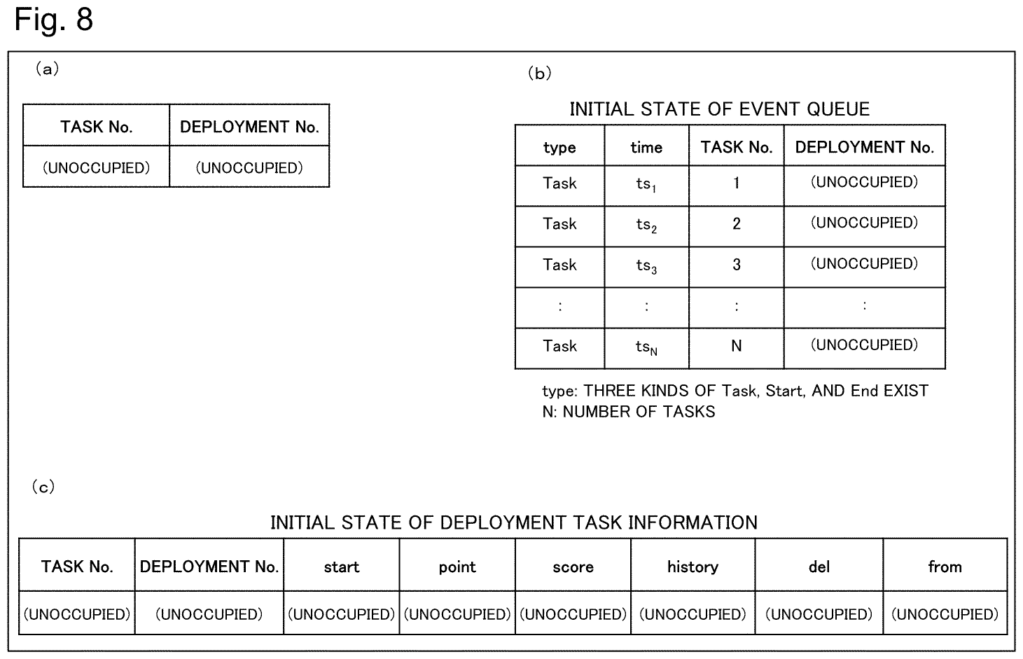

FIG. 8 is a diagram illustrating data structures of (a) the from-candidate list, (b) an event queue, and (c) deployment task information according to the example embodiment of the present invention. The from-candidate list is data having a two-dimensional array structure that includes column items of “task No.” and “deployment No.”. The event queue is an FIFO queue having a two-dimensional array structure that includes column items of “type”, “time”, “task No.”, and “deployment No.”. The item “type” may take three kinds of value of “Task”, “Start”, and “End”. The deployment task information is data having a two-dimensional array structure that includes column items of “task No.”, “deployment No.”, “start”, “point”, “score”, “history”, “del”, and “from”.

Next, in the event queue, the initializing unit 101 substitutes “Task” for all elements in a column of “type”, substitutes “most anterior start time is”, of the task data associated with “task No.” for each element in a column of “time”, substitutes values 1 to N one by one for each element in a column of “task No.”, and substitutes “unoccupied” for all elements in a column of “deployment No.” (step S102).

Next, the initializing unit 101 sorts the event queue in an ascending order of “time” (step S103).

Next, the initializing unit 101 makes each element of all columns of the deployment task information unoccupied (step S104). When step S104 is ended, the initializing unit 101 ends the processing of the initialization S1.

The above is the processing of the initialization S1.

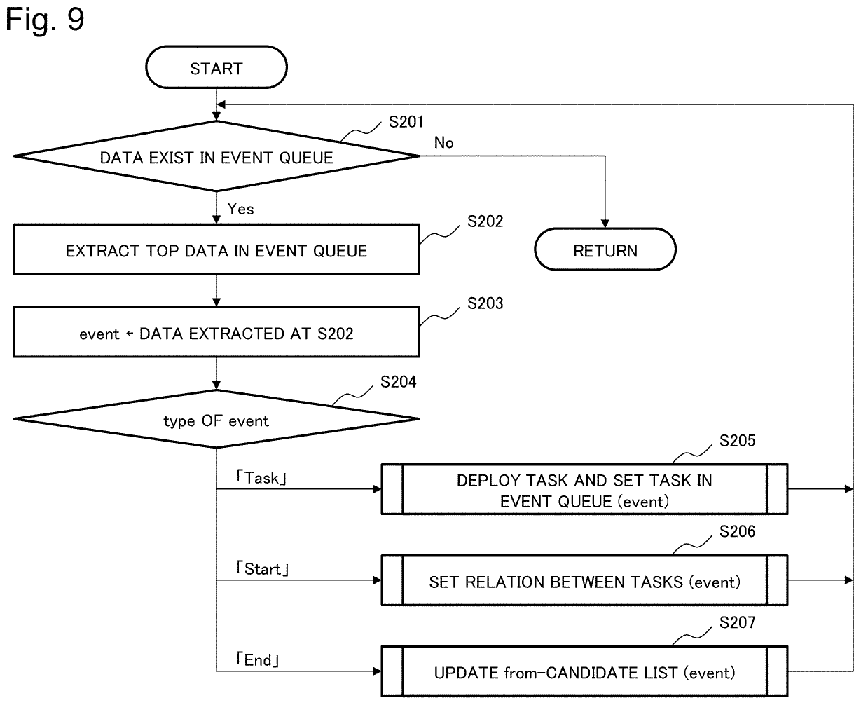

FIG. 9 is a flowchart illustrating the processing of the scheduling of the calculation system according to the example embodiment of the present invention. The following describes the processing of the scheduling S2. The processing of the scheduling S2 is processing of converting task data that are data indicating distribution of a plurality of tasks into a directed graph including a start and a goal, and detecting a longest path from the start to the goal.

The scheduling unit 102 determines whether or not data exist in the event queue (step S201). When data exist in the event queue (yes at step S201), the scheduling unit 102 extracts top data in the event queue (step S202). After step S202, the processing proceeds to step S203. When data do not exist in the event queue (no at step S201), the scheduling unit 102 ends the processing of the scheduling S2.

The scheduling unit 102 substitutes, for a variable “event”, the data extracted at step S202 (step S203).

The scheduling unit 102 determines what is “type” of the variable “event” (step S204).

When “type” of the variable “event” is “Task” at step S204 (“Task” at step S204), the scheduling unit 102 performs processing of deploying a task and setting the task in the event queue (step S205). After step S205, the processing proceeds to step S201.

When “type” of the variable “event” is “Start” at step S204 (“Start” at step S204), the scheduling unit 102 performs processing of setting a relation between tasks (step S206).

After step S206, the processing proceeds to step S201.

When “type” of the variable “event” is “End” at step S204 (“End” at step S204), the scheduling unit 102 performs processing of updating the from-candidate list (step S207). After step S207, the processing proceeds to step S201.

The above is the processing of the scheduling S2.

From here, more detailed description is made on the processing of deploying a task and setting the task in the event queue (step S205).

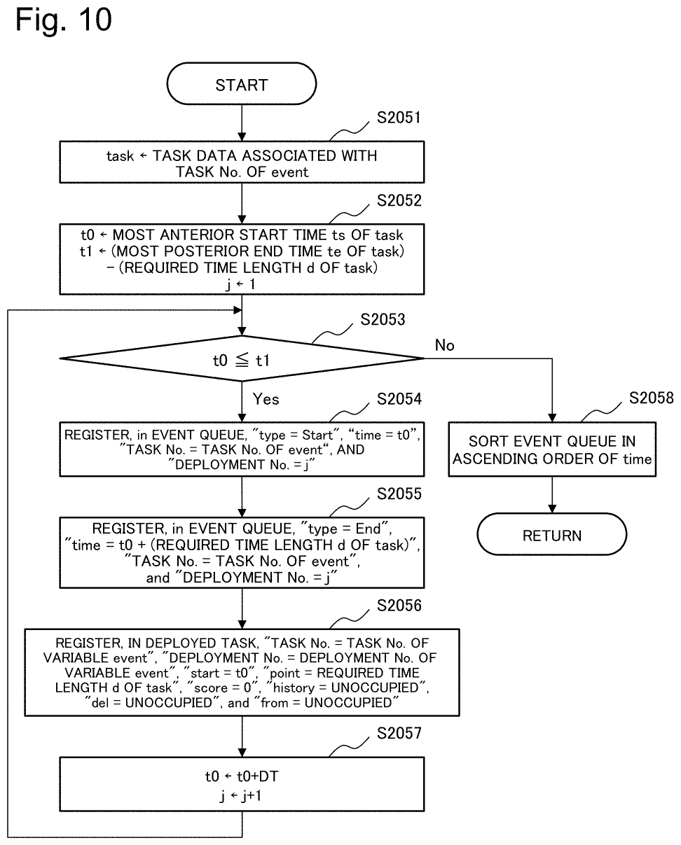

FIG. 10 is a flowchart illustrating the processing of deploying a task and setting the task in the event queue, according to the example embodiment of the present invention. Here, deploying a task means generating a plurality of events (hereinafter, each of the events referred to as a deployed task) associated with start times or end times that can be within a period from the most anterior start time to the most posterior end time of the task. The deployed task associated with the start time and the deployed task associated with the end time are generated separately.

The scheduling unit 102 substitutes, for a variable “task”, task data associated with a task No. of the variable “event” (step S2051). Next, the scheduling unit 102 substitutes a most anterior start time is of the variable “task” for a variable “t0”, substitutes, for a variable “t1”, a value of a difference between a most posterior end time to of the variable “task” and a required time length d of the variable “task”, and substitutes 1 for a variable “j” (step S2052).

Next, the scheduling unit 102 determines whether or not “t0≤t1” is satisfied (step S2053).

At step S2053, when “t0≤t1” is satisfied (Yes at step S2053), next, the scheduling unit 102 registers, in the event queue, data of which “type=Start”, “time=t0”, “task No.=task No. of ‘event’”, and “deployment No.=j” (step S2054). After step S2054, the processing proceeds to step S2055.

When “t0≤t1” is not satisfied at step S2053 (No at step S2053), next, the scheduling unit 102 sorts the event queue in the ascending order of “time” (step S2058). When step S2058 is ended, the scheduling unit 102 ends the processing of the scheduling S2.

The scheduling unit 102 registers, in the event queue, data of which “type=End”, “time=a value of a sum of the variable ‘t0’ and the required time length d of the variable ‘task’”, “task No.=task No. of ‘event’”, and “deployment No.=j” (step S2055).

Next, the scheduling unit 102 registers, in the deployment task information, data of which “task No.=task No. of the variable ‘event’”, “deployment No.=deployment No. of the variable ‘event’”, “start=t0”, “point=required time length d of ‘task’”, “score=0”, “history=(unoccupied)”, “del=(unoccupied)”, and “from =(unoccupied)” (step S2056).

Priority order of tasks can be set by changing a manner of setting “point” at step S2056.

Next, the scheduling unit 102 substitutes a value of “the variable ‘t0’+DT” for the variable “t0”, and substitutes a value of “j+1” for the variable “j” (step S2057). The symbol DT is a preset stepping width of time. The finer the stepping width is, the more accurate the scheduling is. Meanwhile, the narrower the stepping width is, the larger a CPU load is. After step S2057, the processing proceeds to step S2053.

The above is details of the processing of deploying a task and setting the task in the event queue (step S205).

From here, more detailed description is made on the processing of setting a relation between tasks (step S206).

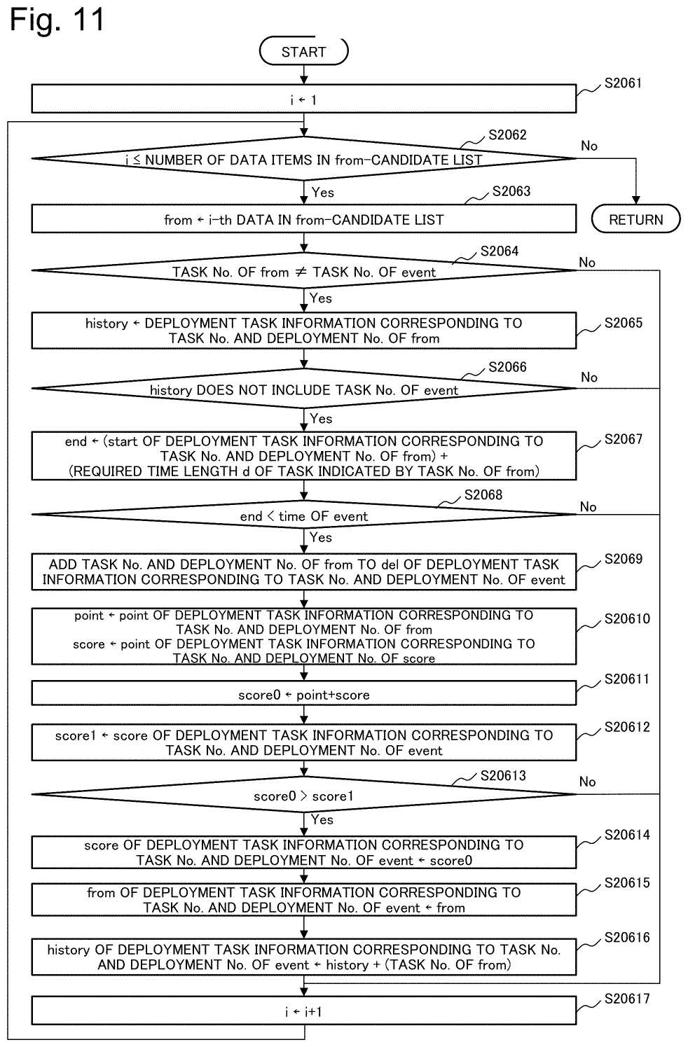

FIG. 11 is a flowchart illustrating the processing of setting a relation between tasks, according to the example embodiment of the present invention. Setting a relation means generating an edge of a directed graph.

The scheduling unit 102 substitutes 1 for a variable “i” (step S2061). Next, the scheduling unit 102 determines whether or not “i≤number of data items in from-candidate list” is satisfied (step S2062).

When “i≤number of data items in from-candidate list” is satisfied at step S2062 (Yes at step S2062), next, the scheduling unit 102 substitutes i-th data in the from-candidate list for a variable “from” (step S2063). After step S2063, the processing proceeds to step S2064.

When “i≤number of data items in from-candidate list” is not satisfied at step S2062 (No at step S2062), the scheduling unit 102 ends the processing of setting a relation between tasks (step S206).

The scheduling unit 102 determines whether or not “task No. of the variable ‘from’≠task No. of the variable ‘event’” is satisfied (step S2064). By this processing, processing on the same task is omitted.

When “task No. of the variable ‘from’≠task No. of the variable ‘event’” is satisfied at step S2064 (Yes at step S2064), next, the scheduling unit 102 substitutes, for a variable “history”, “history” in deployment task information associated with a pair of the task No. and the deployment No. of the variable “from” (step S2065). After step S2065, the processing proceeds to step S2066.

When “task No. of variable ‘from’≠task No. of variable ‘event’” is not satisfied at step S2064 (No at step S2064), the processing proceeds to step S20617.

The scheduling unit 102 determines whether or not “history” includes the task No. of “event” (step S2066). By this processing, processing on a task for which a relation is already set is omitted.

When the variable “history” does not include the task No. of “event” at step S2066 (Yes at step S2066), next, the scheduling unit 102 substitutes, for a variable “end”, a sum of “start” of the deployment task information associated with a set of the task No. and the deployment No. of the variable “from” and a required time length d of task data associated with the task No. of the variable “from” (step S2067). After step S2067, the processing proceeds to step S2068.

When the variable “history” includes the task No. of “event” at step S2066 (No at step S2064), the processing proceeds to step S20617.

The scheduling unit 102 determines whether or not “variable ‘end’<‘time’ of variable ‘event’” is satisfied (step S2068).

When “variable ‘end’<‘time’ of variable ‘event’” is satisfied at step S2068 (Yes at step S2068), next, the scheduling unit 102 adds the task No. and the deployment No. of the variable “from” to “del” of the deployment task information associated with a pair of the task No. and the deployment No. of the variable “event” (step S2069). After step S2069, the processing proceeds to step S20610.

When “variable ‘end’<‘time’ of variable ‘event’” is not satisfied at step S2068 (No at step S2068), the processing proceeds to step S20617.

The scheduling unit 102 substitutes, for a variable “point”, “point” of the deployment task information associated with the pair of the task No. and the deployment No. of the variable “from”, and substitutes, for a variable “score”, “score” of the deployment task information associated with the pair of the task No. and the deployment No. of the variable “from” (step S20610).

Next, the scheduling unit 102 substitutes a value of a sum of the variable “point” and the variable “score” for a variable “score0” (step S20611).

Next, the scheduling unit 102 substitutes, for a variable “score1”, “score” of the deployment task information associated with the pair of the task No. and the deployment No. of the variable “event” (step S20612).

Next, the scheduling unit 102 determines whether or not “variable score0>variable score1” is satisfied (step S20613).

When “variable score0>variable score1” is satisfied at step S20613 (Yes at step S20613), next, the scheduling unit 102 substitutes “score0” for “score” of the deployment task information associated with the pair of the task No. and the deployment No. of the variable “event” (step S20614). After step S20614, the processing proceeds to step S20615.

When “variable score0>variable score1” is not satisfied at step S20613 (No at step S20613), the processing proceeds to step S20617.

The scheduling unit 102 substitutes the variable “from” for “from” of the deployment task information associated with the pair of the task No. and the deployment No. of the variable “event” (step S20615).

Next, the scheduling unit 102 adds the task No. of the variable “from” to “history” of the deployment task information associated with the pair of the task No. and the deployment No. of the variable “event” (step S20616).

Next, the scheduling unit 102 substitutes a value of “the variable i+1” for the variable “i” (step S20617). After step S20617, the processing proceeds to step S2062.

The above is the details of the processing of setting a relation between tasks (step S206).

From here, more detailed description is made on the processing of updating the from-candidate list (step S207).

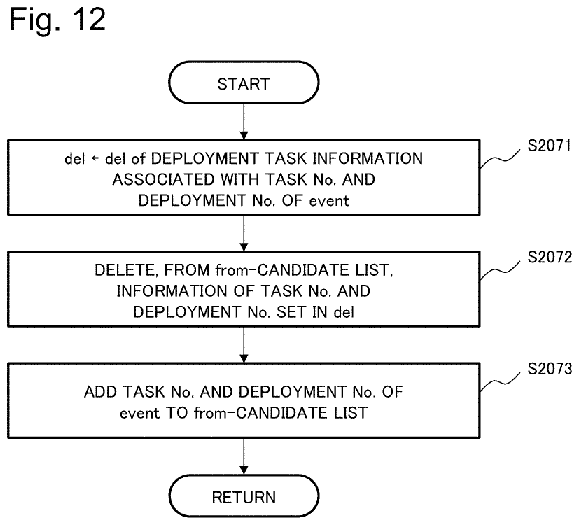

FIG. 12 is a flowchart illustrating the processing of updating the from-candidate list, according to the example embodiment of the present invention.

The scheduling unit 102 substitutes, for a variable “del”, “del” of the deployment task information associated with the pair of the task No. and the deployment No. of the variable “event” (step S2071).

Next, the scheduling unit 102 deletes, from the from-candidate list, the pair of the task No. and the deployment No. set in the variable “del” (step S2072).

Next, the scheduling unit 102 adds, to the from-candidate list, the pair of the task No. and the deployment No. of the variable “event” (step S2073).

The above is the details of the processing of updating the from-candidate list (step S207).

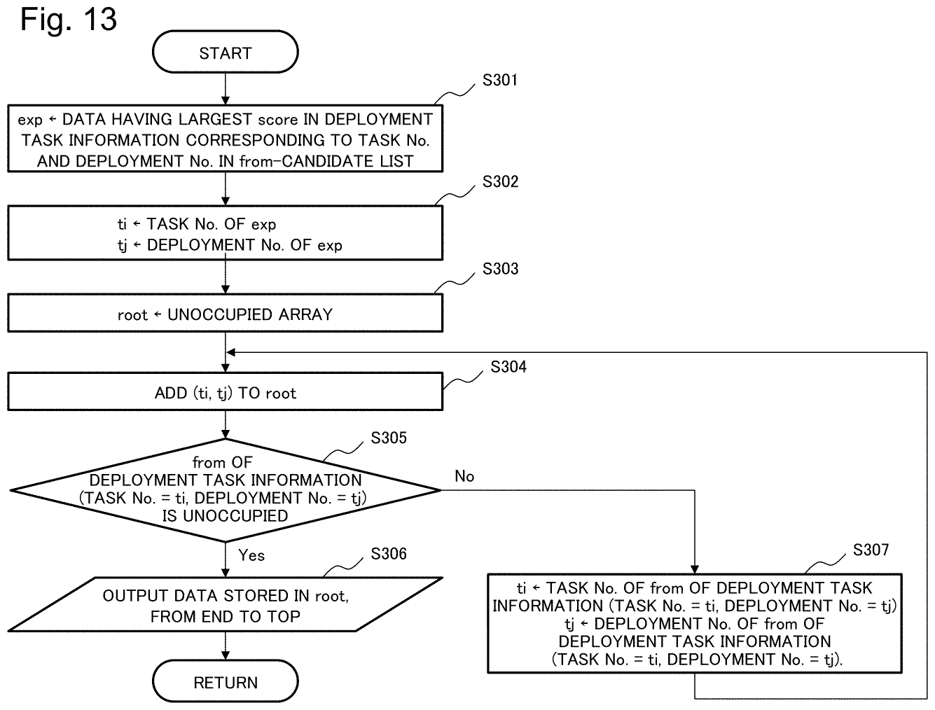

FIG. 13 is a flowchart illustrating the processing of outputting a solution, according to the example embodiment of the present invention. The following describes the processing of the solution outputting S3. The processing of the solution outputting S3 is processing of outputting an detected longest path.

The solution output unit 103 substitutes, for a variable “exp”, data having the largest “score” among a plurality of pieces of the deployment task information respectively associated with each pair of a task No. and a deployment No. in the from-candidate list (step S301).

Next, the solution output unit 103 substitutes a task No. of the variable “exp” for a variable “ti”, and substitutes a deployment No. of the variable “exp” for a variable “tj” (step S302).

Next, the solution output unit 103 sets an unoccupied array in a variable “root” (step S303).

Next, the solution output unit 103 adds a pair of the variable “ti” and the variable “tj” to the variable “root” (step S304).

Next, the solution output unit 103 determines whether or not “from” of the deployment task information (“task No.=ti” and “deployment No.=tj”) is unoccupied (step S305).

When “from” of a variable “deployment task information” (“task No.=ti” and “deployment No.=tj”) is unoccupied at step S305 (Yes at step S305), the solution output unit 103 outputs data stored in “root”, from the end to the top (step S306). When step S306 is ended, the solution output unit 103 ends the processing of the solution outputting S3.

When “from” of the variable “deployment task information” (“task No.=ti” and “deployment No.=tj”) is not unoccupied at step S305 (No at step S305), the solution output unit 103 substitutes, for the variable “ti”, the task No. of “from” of the deployment task information (“task No.=ti” and “deployment No.=tj”), and substitutes, for the variable “tj”, the deployment No. of “from” of the deployment task information (“task No.=ti” and “deployment No.=tj”) (step S307). After step S307, the processing proceeds to step S304.

The above is the processing of the solution outputting S3.

### Advantageous Effect

According to the present example embodiment, in the allocation problem, the optimum combination is able to be efficiently acquired. Further, according to the present example embodiment, it is possible to make application to scheduling for avoiding resource contention in a case of performing a plurality of tasks in parallel, and to scheduling for allocating a large number of tasks to a plurality of persons and minimizing an entire working time length. These are generally called job shop scheduling.

### (Hardware Configuration)

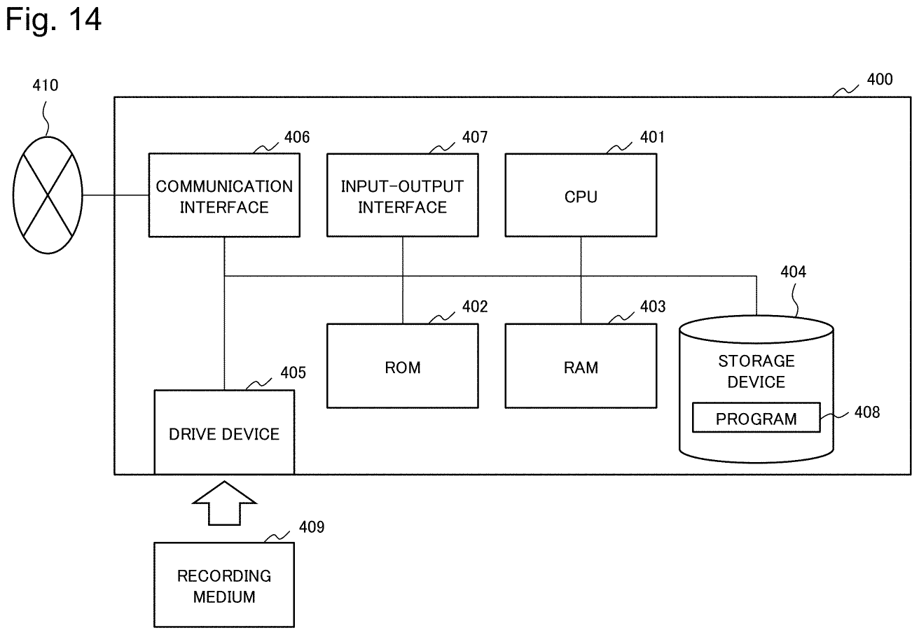

FIG. 14 is a block diagram illustrating one example of a hardware configuration of a computer device according to the example embodiment of the present invention. The computer device 400 is one example of a device that implements the above-described calculation system 100. The computer device 400 includes a central processing unit (CPU) 401, a read only memory (ROM) 402, a random access memory (RAM) 403, a storage device 404, a drive device 405, a communication interface 406, and an input-output interface 407. The calculation system 100 may be implemented by a configuration (or a part thereof) illustrated in FIG. 14.

The CPU 401 executes a program 408, using the RAM 403. The program 408 may be stored in the ROM 402. Alternatively, the program 408 may be stored in a recording medium 409 such as a flash memory and read out by the drive device 405, or may be transmitted from an external device via a network 410. The communication interface 406 exchanges data with an external device via the network 410. The input-output interface 407 exchanges data with a peripheral device (such as an input device or a display device). The communication interface 406 and the input-output interface 407 can function as a means for acquiring or outputting data.

Note that each of the initializing unit 101, the scheduling unit 102, the solution output unit 103, and the like may be configured by a single piece of circuitry (processor or the like), or may be configured by a combination of a plurality of pieces of circuitry. The circuitry mentioned here may be either special-purpose or general-purpose. Alternatively, the initializing unit 101, the scheduling unit 102, the solution output unit 103, and the like may be configured by a single piece of circuitry.

The present invention is not limited to the above-described example embodiment, and various modifications can be made within the scope of the invention described in claims, and needless to say, are also included in the scope of the present invention. In other words, various aspects that can be understood by those skilled in the art can be applied to the present invention within the scope of the present invention.

This application is based upon and claims the benefit of priority from Japanese patent application No. 2017-069456, filed on Mar. 31, 2017, the disclosure of which is incorporated herein in its entirety by reference.

### REFERENCE SIGNS LIST

100 Calculation system
101 Initializing unit
102 Scheduling unit
103 Solution output unit
400 Computer device
401 Central processing unit (CPU)
402 Read only memory (ROM)
403 Random access memory (RAM)
404 Storage device
405 Drive device
406 Communication interface
407 Input-output interface
408 Program
409 Recording medium
410 Network

1. A calculation system comprising, when a plurality of tasks whose start time and end time can each be shifted within a period between a predetermined start time and a predetermined end time are executed as many as possible without overlapping in time:
a memory that stores a set of instructions; and
at least one processor configured to execute the set of instructions to:
convert task data that indicate distribution of the plurality of tasks, into a directed graph that includes a start and a goal, and detect a longest path from the start to the goal; and
output the longest path being detected.

2. The calculation system according to claim 1, wherein, the at least one processor is further configured to execute the set of instructions to:
in conversion into the directed graph, convert one task into a plurality of vertexes each corresponding to each of a plurality of the start times that can be taken by the one task.

3. A calculation method comprising, when a plurality of tasks whose start time and end time can each be shifted within a period between a predetermined start time and a predetermined end time are executed as many as possible without overlapping in time:
converting task data that indicate distribution of the plurality of tasks into a directed graph that includes a start and a goal;
detecting a longest path from the start to the goal; and
outputting the longest path being detected.

4. A non-transitory computer-readable recording medium on which a calculation program is recorded, the program causing a computer to execute, when a plurality of tasks whose start time and end time can each be shifted within a period between a predetermined start time and a predetermined end time are executed as many as possible without overlapping in time:
processing of converting task data that indicate distribution of the plurality of tasks into a directed graph that includes a start and a goal;
processing of detecting a longest path from the start to the goal; and
processing of outputting the longest path being detected.
